(19) United States
(12) Patent Application Publication
(10) Pub. No.: US 2012/0125715 A1
(43) Pub. Date: May 24, 2012

(54) ERGONOMIC LIGHTWEIGHT CLIMBING STICK

(75) Inventors: Michael R. Furseth, Cumberland, WI (US); Randy L. Schamberger, Cumberland, WI (US); Benjamin T. Nelson, Cameron, WI (US)

(73) Assignee: Ardisam, Inc., Cumberland, WI (US)

(21) Appl. No.: 13/048,457

(22) Filed: Mar. 15, 2011

Related U.S. Application Data
(60) Provisional application No. 61/416,820, filed on Nov. 24, 2010.

(51) Int. Cl. E06C 1/06; B21C 23/00; B23P 11/00; E06C 7/50

(52) U.S. Cl. 182/194; 72/253.1; 29/525.11

(57) ABSTRACT

A modular tree climbing ladder including a support member, at least one stabilizing bracket secured to the support member, and a pair of steps pivotally secured to the support member. The support member includes a front piece and a rear piece configured to form two channels that oppose one another and form an interior angle of less than 180 degrees. The steps are each pivotally secured to the support member within one of respective said opposing channels such that each of said steps oppose one another and form an angle equal to said interior angle. The steps are independently rotatable from a vertical (or storage) position to a horizontal (or operational) position. The steps include a stepping surface and are secured to said support member such that respective stepping surfaces are coplanar when both steps are in the horizontal position. The modular tree climbing ladder can further include a securing belt mounting bracket that is secured to the support member.

### RELATED APPLICATIONS

The present application claims the benefit of U.S. Provisional Application entitled Ergonomic Lightweight Climbing Stick, Ser. No. 61/416,820, filed Nov. 24, 2010, which is hereby incorporated by reference.

### BACKGROUND

The present disclosure relates to ladders for outdoor use, and more specifically to modular ladders configured for climbing trees.

Hunters hunting wild game such as deer and bears may find it desirable to place themselves in an elevated position above the line of sight of an animal being hunted to prevent detection by the animal. A tree stand may be used by a hunter to position himself in a tree a number of feet above the ground, above the typical line of sight of the hunted animal.

Positioning the stand at a desired height in a tree, and then climbing the tree to reach the stand can prove challenging for a hunter. In most cases, a hunter may use some type of ladder to reach the portion of the tree on which the tree stand may be positioned. The ladders designed for this purpose may be lightweight, durable, and easily portable.

A conventional stepladder, consisting of a pair of parallel rails separated by a number of steps or rungs attached between the rails, presents certain problems when used for this purpose. The size of most stepladders make them awkward and unwieldy when transported into the normally confined environment of a forest where a tree stand is typically used. Moreover, a conventional stepladder is not equipped with any type of safety device to reliably secure the stepladder to the tree to prevent the ladder from inadvertently sliding off of the tree and injuring a hunter using the ladder.

Other types of ladders have been specially designed for use in connection with hunting tree stands to overcome the problems associated with utilizing a conventional ladder. For example, ladders that utilize a modular construction have been developed and designed to be utilized with trees having irregularly shaped trunks and/or branches extending from the trunk at a low level, conditions which make ladders having a conventional stepladder arrangement unusable.

The individual modules, or climbing sticks, used in forming these modular ladders may typically comprise a number of individual alternating steps secured to an elongate tubular support member. The individual steps are pivotally mounted to the support member, allowing the steps to rotate from a closed, vertical position (in line with a longitudinal axis of the support member) when the module is in transport or is not in use, to an open, horizontal position where the step points outward perpendicular to the support member to provide alternating stepping surfaces for an individual utilizing the modular ladder. The alternating stepping surfaces oppose each other by 180 degrees (i.e., 180 degrees apart as measured around the longitudinal axis of the support member), such that the steps extending in a first direction extend in a direction directly opposite the steps extending in the other direction. Thus, the stepping surfaces are positioned very close to the tree when in use (in the open position). Each module is secured to the tree trunk by a securing belt.

These modular ladders, while effective, still have certain shortcomings. In particular, the orientation of the alternating steps can in some instances be challenging because, in the open position the steps are positioned substantially close to the trunk of the tree. The close proximity of the steps to the tree provide limited access to (or foot engagement with) the stepping surface.

### BRIEF SUMMARY

The present disclosure is directed to embodiments of a modular ladder providing steps that extend away from the trunk of a tree when in the opened position to provide substantially more access to the stepping surface of a step.

### BRIEF DESCRIPTION OF THE DRAWINGS

The written disclosure herein describes illustrative embodiments that are non-limiting and non-exhaustive. Reference is made to certain of such illustrative embodiments that are depicted in the figures, in which:

FIG. 1 is a front side view of a tree climbing ladder, according to one embodiment of the present disclosure.

FIG. 2 is a perspective view of a tree climbing ladder, according to one embodiment of the present disclosure.

FIG. 3 is an exploded view of a tree climbing ladder, according to one embodiment of the present disclosure.

FIG. 4 is a top view of a tree climbing ladder, according to one embodiment of the present disclosure.

FIG. 5 is a top view of a stabilizing bracket of a tree climbing ladder, according to one embodiment of the present disclosure.

FIG. 6 is a side view of a step of a tree climbing ladder, according to one embodiment of the present disclosure.

FIGS. 7A-7C are a support member of a tree climbing ladder, according to one embodiment of the present disclosure.

### DETAILED DESCRIPTION OF PREFERRED EMBODIMENTS

The embodiments of the disclosure will be best understood by reference to the drawings, wherein like parts are designated by like numerals throughout. It will be readily understood that the components of the disclosed embodiments, as generally described and illustrated in the figures herein, could be arranged and designed in a wide variety of different configurations. Thus, the following detailed description of the embodiments of the systems and methods of the disclosure is not intended to limit the scope of the disclosure, as claimed, but is merely representative of possible embodiments of the disclosure. In addition, the steps of a method do not necessarily need to be executed in any specific order, or even sequentially, nor need the steps be executed only once, unless otherwise specified.

In some cases, well-known features, structures or operations are not shown or described in detail. Furthermore, the described features, structures, or operations may be combined in any suitable manner in one or more embodiments. It will also be readily understood that the components of the embodiments as generally described and illustrated in the figures herein could be arranged and designed in a wide variety of different configurations.

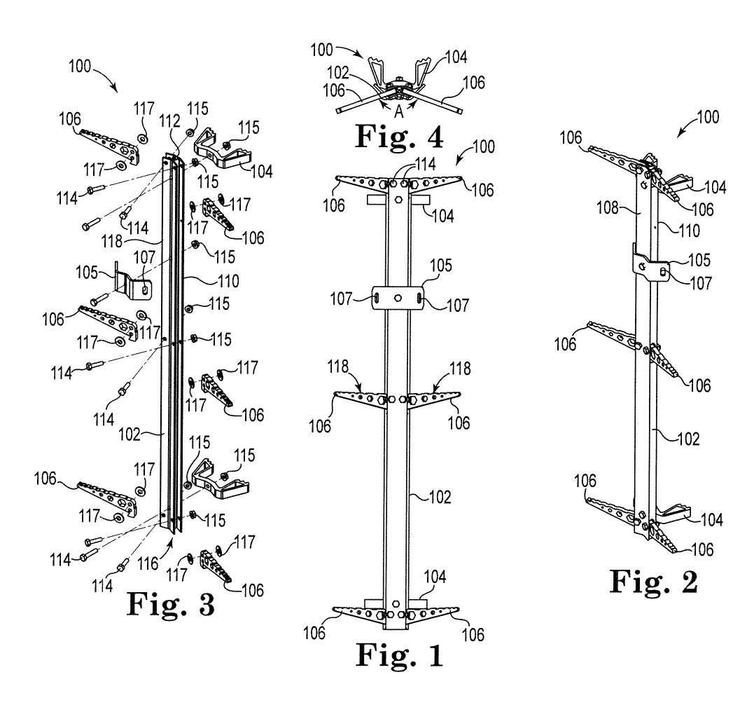

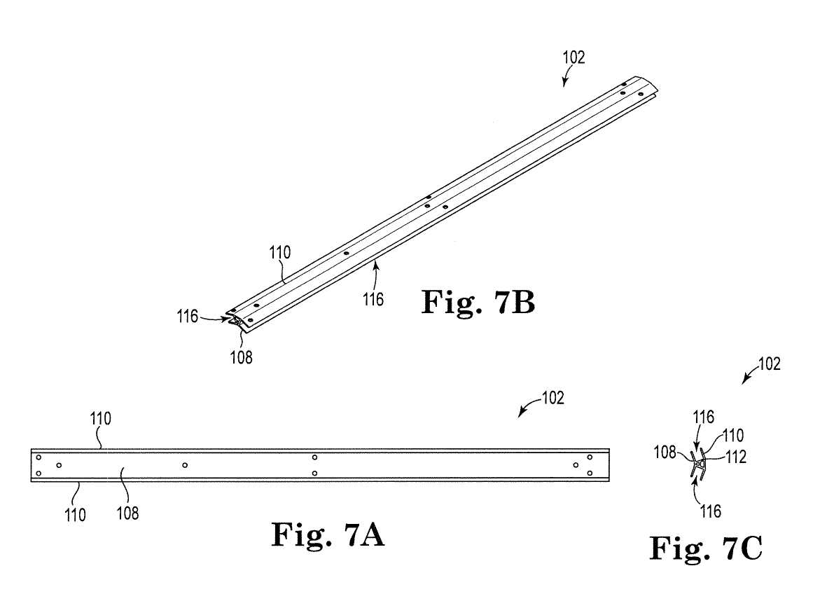

FIGS. 1-4 depict a tree climbing ladder 100, according to one embodiment of the present disclosure. Referring collectively to FIGS. 1-4, The tree climbing ladder comprises a support member 102, one or more stabilizing brackets 104, a securing belt mounting bracket 105, and a plurality of steps 106. The support member 102 may comprise an elongate shaft formed from a front piece 108 and a back piece 110 joined by a center column 112. The space or grooves 116 between the front piece 108 and the back piece 110, along either side of the center column 112, may be configured to receive the steps 106. As can be appreciated, in one embodiment, the front piece 108, the back piece 110, and the center column 112 may be substantially integrated as a single piece. In still another embodiment, the support member 102, including the front piece 108, the back piece 110, and the center column 112 may be integrally formed, such as by molding, extruding, machining, or other process. The support member 102 may be composed using a strong light weight material such as aluminum. The support member 102 is also depicted in FIGS. 7A-7C and discussed below with reference to the same.

The securing belt mounting bracket 105 may be configured to mount flush against a face of the support member 102. The securing belt mounting bracket 105 can be connected to the support member 102 using a bolt 114 and nut 115 combination, or pin, or other connector positioned through the securing belt mounting bracket 105 and support member 102. The securing belt mounting bracket 105 includes two slots 107. The slots 107 may allow a securing belt (not shown) to be attached to the securing belt mounting bracket 105 using spring clips or carabiners.

The front piece 108 is configured to form an angle A about the longitudinal axis of the support member 102 (as illustrated in FIG. 4). In other words, a transverse cross-section of the front piece 108 forms the angle A. The angle A may be between ninety degrees and one hundred and eighty degrees. In one embodiment, the angle A may be approximately one hundred and forty degrees. The securing belt mounting bracket 105 can be configured to nest within the angle A on the front piece 108 of the support member 102.

The back piece 110 is also configured to form an angle about the longitudinal axis of the support member 102 equal to the angle A. Accordingly, the back piece 110 may substantially conform to the shape of the front piece, separated by a distance equivalent to the thickness of the center column 112 to form the grooves 116.

As mentioned, the space (e.g., groove) between the front piece 108 and the back piece 110, along either side of the center column 112, may be configured to receive the steps 106. A bolt 114 and a nut 115 combination, pin, or other connector secures the step 106 to the support member 102 in the groove 116. The bolt 114 is positioned through the front piece 108, through a step 106 positioned in the groove 116, and through the back piece 110. The bolt 114 can function as a pivot about which the step can rotate from a closed position to an open position. Moreover, washers 117 can be placed adjacent front and rear faces of the steps 106. The washers 117 can be composed of metal or nylon. The washers 117 help secure steps 106 within the grooves 116 and reduce noise when a step 106 is rotated, as described below.

The steps 106 may be configured to rotate about the bolt 114 from an upright, or closed, position, downward to an open, or horizontal, position. A portion of the step 106 may be configured to abut the center column 112 when the step 106 is in the horizontal position, thereby preventing further downward rotation of the step 106 to provide a firm foothold. The step 106 may further comprise a stepping surface 118 configured to provide traction and/or sure footing for an individual standing on the step 106.

As shown in the figures, the steps 106 may be positioned at intervals along the support member in pairs. A first step may rotate to an open position along, for example, the left side, such that the step 106 extends from the support member 102 substantially to the left of the support member 102. A corresponding second step may rotate to an open position along, for example, the right side, such that the step extends from the support member 102 substantially to the right of the support member 102. As can be appreciated, in another embodiment the steps 106 may alternate sides, such that they are not positioned in pairs.

As shown best in FIG. 4, the angled shape of the support member 102 allows the steps 106 in the horizontal position to extend away from a tree. In other words, the steps 106 on, for example, the left side oppose the steps 106 on, for example, the right side at an angle less than one hundred eighty degrees. In FIG. 4, the angle between the extended, open steps 106 is substantially equal to angle A. The angle A is less than one hundred eighty degrees. More particularly, the angle A may be approximately one hundred forty degrees. The smaller angle (less than one hundred eighty degrees provides a slightly “V” shape allowing the steps to extend further away from the tree without creating a taller profile when the tree climbing ladder 100 is nested with another tree climbing ladder, such as for example during transport. More foot engagement with the steps 106 is possible without significantly enlarging the thickness of the support member 102.

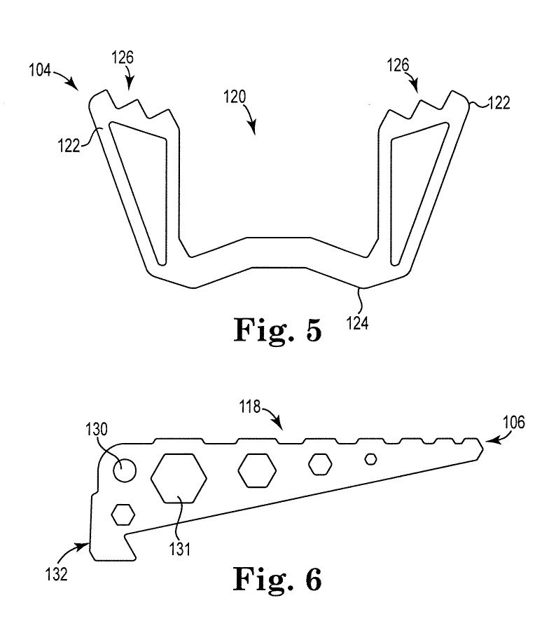

FIG. 5 is a top view of a stabilizing bracket 104 of a tree climbing ladder 100, according to one embodiment of the present disclosure. The stabilizing brackets support the tree climbing ladder 100 on the tree. The stabilizing bracket 104 may be generally “U” shaped having a pair of engagement members 122 extending from a base 124. The engagement members 122 form a slot 120 shaped and configured sufficiently wide to receive a support member 102 of another tree climbing ladder 100, allowing multiple tree climbing ladders 100 to be nested together in a transport configuration for easy transport. The base 124 of the stabilizing bracket 104 may be secured to the support member 102 with a bolt or other securement mechanism. The engagement members may include teeth 126 to provide better grip or engagement of a tree trunk.

The climbing ladder 100 may include a pair of stabilizing brackets 104 positioned at the upper and lower ends of the support member 102. The stabilizing brackets 104 may engage the trunk of the tree to limit sliding of the climbing ladder 100 downwardly along the trunk of the tree while supporting an individual. The stabilizing brackets 104 may be rotatably mounted to each end of the support member 102 to allow each stabilizing bracket 104 to independently conform to the direction in which the tree trunk extends.

FIG. 6 is a side view of a step 106 of a tree climbing ladder 100, according to one embodiment of the present disclosure. The step 106 includes a pivot point 130, which may be a hole configured to receive a bolt 114 or other pivot. The step 106 also includes a shoulder 132 configured to abut the center column 112 of the support member 102 and thereby restrict the range of downward rotation of the step 106 about the pivot point 130. The step 106 also includes a stepping surface 118 to provide a sure foothold for a climber's foot on the step 106. The step 106 also includes a plurality of hexagon cutouts 131 through its face. The hexagon cutouts 131 reduce the amount of material of a step 106 while providing or maintaining structural strength of the step.

FIGS. 7A-7C are a support member 102 of a tree climbing ladder 100, according to one embodiment of the present disclosure. FIG. 7A is a front side view of the support member 102. FIG. 7B is a perspective view of the support member 102.

FIG. 7C is a top view of the support member.

It will be obvious to those having skill in the art that many changes may be made to the details of the above-described embodiments without departing from the underlying principles of the invention.

What is claimed is:

1. A modular tree climbing ladder comprising:
a support member comprising a front piece and a rear piece configured to form two channels that oppose one another and form an interior angle of less than 180 degrees;
at least one stabilizing bracket secured to said support member; and
a pair of steps, each pivotally secured to said support member within one of respective said opposing channels such that each of said steps oppose one another and form an angle equal to said interior angle and are independently rotatable from a vertical position to a horizontal position.

2. The modular tree climbing ladder of claim 1, wherein said interior angle is approximately 140 degrees.

3. The modular tree climbing ladder of claim 2, further comprising a securing belt mounting bracket secured to said support member, wherein said securing belt mounting bracket is configured to conform to the shape of said front piece.

4. The modular tree climbing ladder of claim 1, wherein said pair of steps include respective stepping surface and are secured to said support member such that respective stepping surfaces are coplanar when both steps are in the horizontal position.

5. The modular tree climbing ladder of claim 1, wherein said support member further comprises a center column joining said front piece and said rear piece, wherein the center column prevents further downward rotation of each of said pair of steps when each of said pair of steps are in the horizontal position.

6. The modular tree climbing ladder of claim 5, wherein said front piece, rear piece, and center column are integrated as a single piece.

7. The modular tree climbing ladder of claim 6, wherein each of said steps include a hexagon shaped cutout through each respective face.

8. A modular tree climbing ladder comprising:
an extruded support member configured to form two channels that oppose one another about a center column; and
at least one pair of steps, each pivotally secured to said support member within one of respective said opposing channels such that each of said pair of steps oppose one another about said center column and are independently rotatable from a vertical position to a horizontal position, wherein said center column limits the downward rotation of each of said steps such that said steps cannot rotate downward past said horizontal position.

9. The modular tree climbing ladder of claim 8, wherein said center column is configured such that when said steps are in the horizontal position their respective stepping surfaces form an interior angle of approximately 140 degrees.

10. The modular tree climbing ladder of claim 9, wherein each of said steps include a hexagon shaped cutout through each respective face.

11. The modular tree climbing ladder of claim 10, further comprising a securing belt mounting bracket configured to mount flush against a face of said extruded support member.

12. The modular tree climbing ladder of claim 11, wherein said securing belt mounting bracket is configured to attach to a securing belt using a pair of spring clips.

13. The modular tree climbing ladder of claim 12, wherein said at least one pair of steps include respective stepping surfaces and are secured to said support member such that respective stepping surfaces are coplanar when both steps are in the horizontal position.

14. The modular tree climbing ladder of claim 13, further comprising at least one stabilizing bracket secured to said support member, wherein said stabilizing bracket comprises a base and a pair of engagement members extending from said base, wherein said engagement members form a slot wider than said a support member.

15. A method of manufacturing a modular tree climbing ladder:
forming an extruded support member with two opposing channels about a center column; and
securing a pair of steps to said extruded support member within each of said two opposing channels such that said steps are rotatable from a vertical position to a horizontal position, where said center column prevents said steps from rotating downward past said horizontal position.

16. The method of claim 15, wherein said each of said steps are secured by placing a bolt through each of said steps and said support member.

17. The method of claim 16, further comprising securing a stabilizing bracket to said support member.

18. The method of claim 17, further comprising securing a securing belt mounting bracket to said extruded support member.

19. The method of claim 18, wherein forming an extruded support member with two opposing channels about a center column further comprises forming a center column geometry such that said two opposing channels form an interior angle of less than 180 degrees.

20. The method of claim 19, wherein forming an extruded support member with two opposing channels about a center column further comprises forming a center column geometry such that said two opposing channels forming an interior angle of approximately 140 degrees.
